(19) United States
(12) Patent Application Publication
(10) Pub. No.: US 2016/0167309 A1
(43) Pub. Date: Jun. 16, 2016

(54) CLOSED-LOOP CONTROL FUSED DEPOSITION MODELING HIGH-SPEED 3D PRINTER AND CLOSED-LOOP CONTROL METHOD

(71) Applicant: PANOWIN TECHNOLOGIES CO., LTD, Shanghai (CN)

(72) Inventors: Haichuan LIU, Yangpu Shanghai (CN); Zhenguo YUAN, Yangpu Shanghai (CN); Jinfa LIN, Yangpu Shanghai (CN)

(73) Assignee: PANOWIN TECHNOLOGIES CO., LTD, Yangpu Shanghai (CN)

(21) Appl. No.: 14/908,662

(22) PCT Filed: Jul. 30, 2014
(86) PCT No.: PCT/CN2014/083358

§ 371 Date: Jan. 29, 2016

(30) Foreign Application Priority Data
Jul. 31, 2013 (CN) 201310330304.X
Jul. 25, 2014 (CN) 201420415341.0

(51) Int. Cl. B29C 67/00

(52) U.S. Cl. CPC B29C 67/0088; B29C 67/0055; B33Y 30/00

(57) ABSTRACT

The present invention relates to a high-speed 3D printer with fused deposition modeling under a closed-loop control and a closed-loop control method thereof, and belongs to the technical field of 3D printing. Since the 3D printer has the grating module in which the grating scale is fixed on the machine frame and the grating reader moves along with the running mechanism, a precise mechanical displacement information of the extrusion spray head can be obtained. For the cross printing running mechanism, a precise movement compensation is realized through the compensation of the closed-loop control to improve the accuracy of the position of the extrusion spray head, and thus greatly improve the accuracy of 3D printing to be able to meet the technical requirements of high-accuracy printing. Moreover, the high-speed 3D printer with fused deposition modeling under closed-loop control of the invention has a relatively simple structure and low cost, and the control method of the invention is easy to implement and has a very wide range of application.

### TECHNICAL FIELD

The invention pertains to the technical field of 3D printing, in particular, to a 3D printer structure and 3D printing control method. Specifically, the invention discloses a high-speed 3D printer with fused deposition modeling under closed-loop control and a closed-loop control method.

### BACKGROUND

Fused Deposition Modeling (FDM) is a commonly used process for 3D printing. In the process, a fused filament-like material such as fused filament of thermoplastic, wax or metal is extruded onto a substrate or a cured substance to get deposited and cured, by a heating head which is controlled by an XY running mechanism, according to the profile and of the filling trajectory of data of each sliced layer with a predetermined thickness in the 3D model of element, thus forming the required element layer by layer.

The disadvantage of existing 3D printers with FDM is that the moving mechanism which drives the spray head will cause some errors, due to its structure or the effect of being controlled, etc, which makes the 3D printers difficult to meet the relevant technical requirements while applied to the printing of product with high accuracy requirements.

A mechanism for realizing electronic subdivision of grating comprises a grating scale and a grating reader, of which the operating principle is based on the Moire fringe theory in physics. As shown in FIG. 1, when a line on the grating reader forms a certain angle θ which is very small with a line on the grating scale, the lines on two gratings will intersect with each other. Under the irradiation of parallel lights, the stripes in view which are perpendicular to the lines of gratings and are alternated with brightness and darkness are Moire fringes.

In FIG. 1, W is a width of the Moire fring, d is a spacing of grating, then the following geometric relationship is established:

$$W = \frac{d}{sin θ}$$

If θ is very small and sin θ≈θ, then the above equation can be approximately written as:

If d=0.01 mm. θ=0.01 rad, then it can derived from the above equation that W=1 mm.

$$W = \frac{d}{θ}$$

Thus, it can be seen that, according to the Moire fringe principle, a width of Moire fringe is 100 times larger than a fine grating spacing.

While there is relative movement between two gratings continuously, the Moire fringe will move along the direction which is perpendicular to the gratings. When the distance of relative movement between two gratings is one grating spacing d, the Moire fringe will correspondingly move by one Moire fringe width W. When the direction of relative movement between the two grating scales is changing, the moving direction of Moire fringe will also change therewith.

According to the Moire fringe principle, when the light source emits parallel lights, the light intensity through the Moire fringe is a cosine function. If two light-passing windows A and B are selected in the moving direction of More fringe of the grating reader, then two cosine function varying waveforms with 90 degrees phase shift therebetween as shown in FIG. 2 can be obtained.

In the grating reader, a photosensitive element is used to convert light intensity signals into electrical signals, and convert cosine signals into pulse signals, thus two sets of pulse signals with 90 degrees phase shift therebetween as shown in FIG. 2 can be obtained. The movement control system can obtain the actual relative displacement between two gratings and the direction of two gratings by detecting pulse signals of phase A and phase B.

### SUMMARY

The object of the invention is to overcome the above disadvantages in the prior art and provide a high-speed 3D printer with fused deposition modeling under closed-loop control and a closed-loop control method, which employ the grating technology to compensate the error of movement of moving mechanism effectively, thus greatly improving accuracy of printing and being able to meet the technical requirements of high-accuracy printing. Moreover, the invention has a relatively simple structure and low cost, is easy to implement, and has a very wide range of application.

In order to achieve the above object, the high-speed 3D printer with fused deposition modeling under closed-loop control according to present invention is configured to comprise:

a machine frame;

a printing running mechanism connected to the machine frame;

a printing platform connected to the printing running mechanism:

an extrusion spray head connected to the printing running mechanism;

a drive module for driving the printing running mechanism;

a grating module fixed to the machine frame and the printing running mechanism for detecting the actual displacement of the extrusion spray head; and

a control module for controlling the drive module according to a predetermined printing data and perform a compensating control according to the error between the actual displacement of the extrusion spray head and the printing data.

In the high-speed 3D printer with fused deposition modeling under closed-loop control, the printing running mechanism is a crisscross printing running mechanism provided with an X axis and a Y axis that are perpendicular to each other; and, the extrusion spray head is fixed at the position where the X axis and the Y axis intersect and can be moved along the X axis and the Y axis under the control of the drive module.

In the high-speed 3D printer with fused deposition modeling under closed-loop control, the grating module comprises:

an X axis grating scale, which is fixed to the machine frame and in parallel with the X axis;

a Y axis grating scale, which is fixed to the machine frame and in parallel with the Y axis:

an X axis grating reader, which is fixed to one end of the Y axis that is close to the X axis grating scale, and can be moved along the X axis grating scale along with the movement of the Y axis and connected with the control module for cooperating with the X axis grating scale to read the data which is indicating the displacement of the extrusion spray head along the X axis; and,

a Y axis grating reader, which is fixed to one end of the X axis that is close to the Y axis grating scale, and can be moved along the Y axis grating scale along with the movement of the X axis and connected with the control module for cooperating with the Y axis grating scale to read the data which is indicating the displacement of the extrusion spray head being along the Y axis.

In the high-speed 3D printer with fused deposition modeling under closed-loop control, the drive module comprises:

an X axis motor, which is connected to the control module for driving the extrusion spray head to move along the X axis under the control of the control module; and,

a Y axis motor, which is connected to the control module for driving the extrusion spray head to move along the Y axis under the control of the control module.

In the high-speed 3D printer with fused deposition modeling under closed-loop control, at least one end of the X axis grating scale and/or the Y axis grating scale is fixed to the machine frame via a grating fine adjuster, and the grating fine adjuster comprises a fixed block and an adjusting block;

the fixed block is fixedly mounted onto the machine frame; and,

the adjusting block is movably connected with the fixed block and further provided with an insertion groove for receiving the grating scale.

In the high-speed 3D printer with fused deposition modeling under closed-loop control, the control module comprises a compensation control unit, and if both the X axis motor and the Y axis motor are step motors, the compensation control unit determines the number N′ of steps of the X axis step motor and the Y axis step motor which have been compensated according to the following formulas:

$${N}^{′} = \frac{S}{p} + \frac{( M - m ) d}{p} , ( M > m )$$

$$or$$

$${N}^{′} = \frac{S}{p} + \frac{( m - M ) d}{p} , ( m > M )$$

wherein S is a distance of the extrusion spray head required to move, p is the movement distance of the extrusion spray head driven by one step of the step motor; d is the grating spacing of the grating module; M is the number of gratings that the extrusion spray head needs to pass through while the extrusion spray moves by the distance S according to the printing data, and m is the number of gratings that the extrusion spray head actually pass through.

In the high-speed 3D printer with fused deposition modeling under closed-loop control, the printing running mechanism is a dual-crisscross printing running mechanism which comprises two parallel X axes and two parallel Y axes; and, the X axes are perpendicular to the Y axes, and the extrusion spray head is fixed at a position where the two X axes and the two Y axes intersect.

In the high-speed 3D printer with fused deposition modeling under closed-loop control, the printing running mechanism further comprises a Z axis which is fixed to the machine frame and perpendicular to the X axis and the Y axis, and, the printing platform is connected to the Z axis and moves perpendicularly along the Z axis.

Another aspect of the invention provides a closed-loop control method for a printing running mechanism using the high-speed 3D printer, which comprises the following steps:

(1) the drive module controls the movement of the printing running mechanism according to the printing data;

(2) the grating module detects the actual displacement of the extrusion spray head;

(3) the control module compares the actual displacement with the printing data so as to determine the error;

(4) the control module controls the drive module to perform compensation according to the error.

In the closed-loop control method for a printing running mechanism using the high-speed 3D printer, the printing running mechanism is a crisscross printing running mechanism provided with an X axis and a Y axis perpendicular to each other, the drive module comprises an X axis step motor and a Y axis step motor, the control module comprises a compensation control unit, and the step (4) specifically comprises the following steps:

(41) the compensation control unit determines the number N′ of steps of the X axis step motor and the Y axis step motor which have been compensated according to the following formulas:

$${N}^{′} = \frac{S}{p} + \frac{( M - m ) d}{p} , ( M > m )$$

$$or$$

$${N}^{′} = \frac{S}{p} + \frac{( m - M ) d}{p} , ( m > M )$$

wherein S is a distance of the extrusion spray head required to move, p is the movement distance of the extrusion spray head driven by one step of the step motor; d is the grating spacing of the grating module; M is the number of gratings that the extrusion spray head needs to pass through while the extrusion spray moves by the distance S according to the printing data, and m is the number of gratings that the extrusion spray head actually pass through;

(42) the compensation control unit determines the number ΔN of steps compensated for the X axis step motor or the Y axis step motor according to the following formulas:

ΔN=N′—N

wherein N is the number of steps required for the X axis step motor and the Y axis step motor when the extrusion spray head moves by the distance S according to the printing data.

In the closed-loop control method for a printing running mechanism using the high-speed 3D printer, the printing running mechanism is a crisscross printing running mechanism provided with an X axis and a Y axis that are perpendicular to each other, the drive module comprises an X axis step motor and a Y axis step motor, the control module comprises a compensation control unit, and the step (3) further comprises steps of determining non-perpendicularity error of the X axis or Y axis in case that the cross axes formed by the X axis and the Y axis is deviated from an ideal position by an angle δ, as follows:

(31) merely controlling the X axis to move by a displacement Sx, wherein the single axis movement of the X axis will generate a corresponding offset of Y axis via the coupling of a central slider:

Δy=Sₓg sin δ

(32) detecting the offset of Y axis as the non-perpendicularity error of the Y axis for modifying the displacement of the Y axis in step (4); and,

in the above steps, the X axis and the Y axis can be exchanged.

With the high-speed 3D printer with fused deposition modeling under closed-loop control and the closed-loop control method of the invention, since the 3D printer has the grating module in which the grating scale is fixed on the machine frame and the grating reader moves along with the running mechanism, a precise mechanical displacement information of the extrusion spray head can be obtained. For the printing running mechanism with XY axes, a precise movement compensation is realized through the compensation of the closed-loop control to improve the accuracy of the position of the extrusion spray head, and thus greatly improve the accuracy of 3D printing to be able to meet the technical requirements of high-accuracy printing. Moreover, the high-speed 3D printer with fused deposition modeling under closed-loop control of the invention has a relatively simple structure and low cost, and the control method of the invention is easy to implement and has a very wide range of application.

### BRIEF DESCRIPTION OF THE DRAWINGS

FIG. 1 is a schematic view showing the Moire fringe principle employed by a grating module in the prior art:

FIG. 2 is a schematic view of pulse signals of A and B phases shown in FIG. 1.

FIG. 3 is a front view of structure of a high-speed 3D printer with fused deposition modeling under closed-loop control according to an embodiment of the present invention:

FIG. 4 is a side view of the structure of the high-speed 3D printer with fused deposition modeling under closed-loop control according to an embodiment of the present invention;

FIG. 5 is a schematic view of structure of a crisscross printing running mechanism of high-speed 3D printer with fused deposition modeling under closed-loop control according to an embodiment of the present invention;

FIG. 6 is a schematic view of structure of a Z axis assembly (including a printing platform) of printing running mechanism of high-speed 3D printer with fused deposition modeling under closed-loop control according to an embodiment of the present invention;

FIG. 7 is a schematic view of structure of a joint where various axes are connected by copper sleeve in a printing running mechanism of high-speed 3D printer with fused deposition modeling under closed-loop control according to an embodiment of the present invention;

FIG. 8 is a schematic view showing a closed-loop compensation control of a dual-crisscross printing running mechanism used in an embodiment of the present invention:

FIG. 9 is a block diagram of a control system of 3D printer according to an embodiment of the present invention:

FIG. 10 is a schematic view of structure of a dual-crisscross printing running mechanism used in an embodiment of the present invention;

FIG. 11 is a view showing a comparison between the coordinate system of X axis grating scale and Y axis grating scale in an ideal state and that in a twisted state in an embodiment of the present invention;

FIG. 12 is a schematic view showing the structure of X axis grating scale with two ends both provided with a grating fine adjuster in an embodiment of the present invention;

FIG. 13A is a schematic view of the structure of grating fine adjuster in an embodiment of the present invention, and FIG. 13B is a bottom view of FIG. 13A.

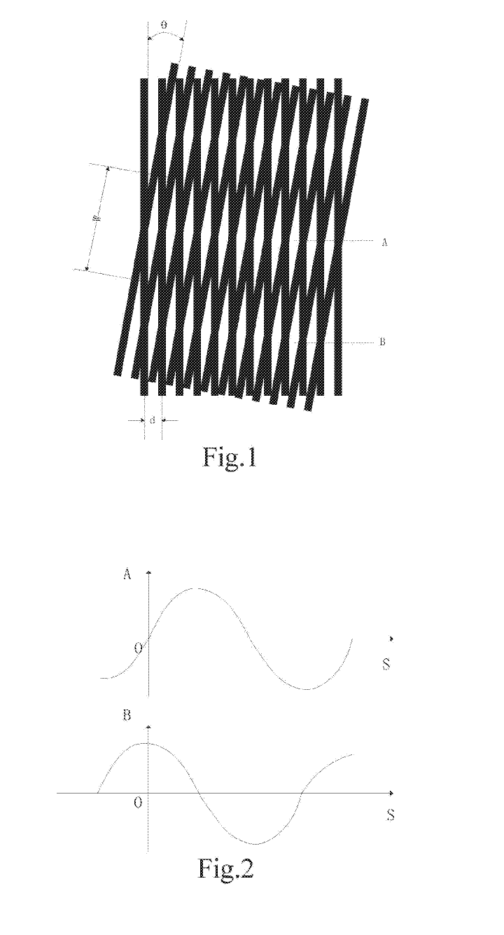

### DETAILED DESCRIPTION

The following embodiments will be described in detail in order that the technical solutions of the invention can be more clearly understood.

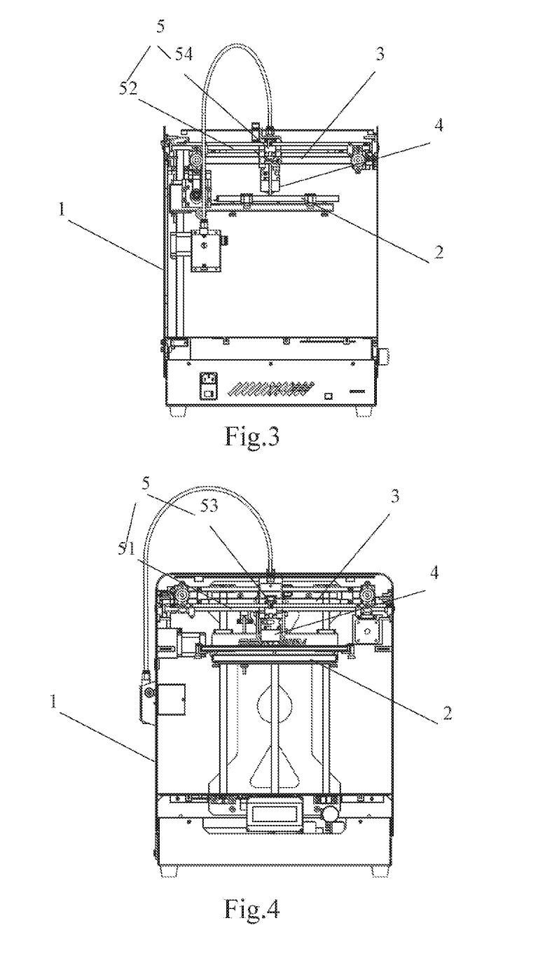

Please refer to FIGS. 3 and 4, which are the schematic views of the structure of high-speed 3D printer with fused deposition modeling under closed-loop control according to an embodiment of the present invention.

In an embodiment, the high-speed 3D printer with fused deposition modeling under closed-loop control comprises: a machine frame 1; a printing running mechanism 3 connected to the machine frame 1; a printing platform 2 connected to the printing running mechanism 3; an extrusion spray head 4 connected to the printing running mechanism 3; a drive module (not shown) connected to and driving the printing running mechanism 3; a grating module 5 fixed to the machine frame 1 and the printing running mechanism 3 for detecting an actual displacement of the extrusion spray head 4; and a control module (not shown) for controlling the drive module according to a predetermined printing data and performing a compensating control according to an error between an actual displacement of the extrusion spray head 4 and the printing data.

The closed-loop control method for a printing running mechanism using the fused deposition modeling high-speed 3D printer according to the embodiment comprises the following steps:

(1) the drive module controls a movement of the printing running mechanism according to the printing data;

(2) the grating module detects an actual displacement of the extrusion spray head fixed to the printing running mechanism;

(3) the control module compares the actual displacement with the printing data so as to determine the error:

(4) the control module controls the drive module to perform compensation according to the error.

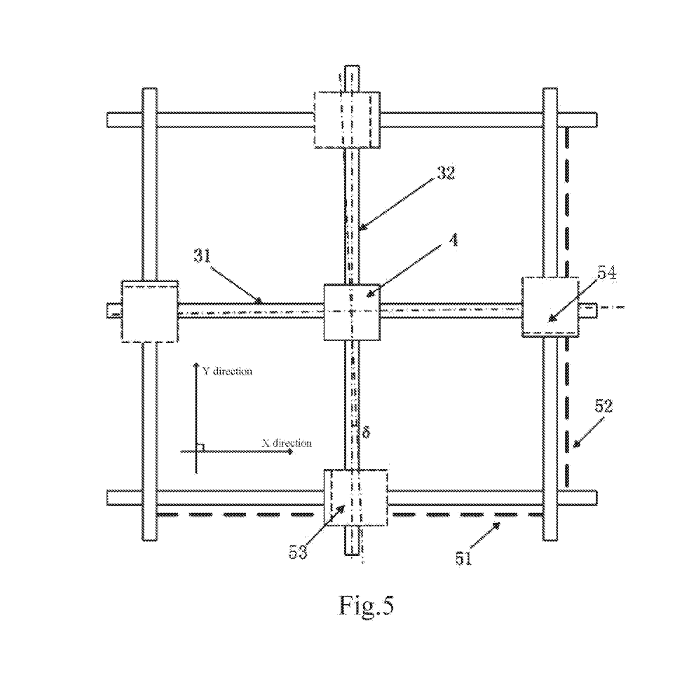

In a preferable embodiment, the printing running mechanism 3 as shown in FIG. 5, is a crisscross printing running mechanism having an X axis 31 and a Y axis 32 that are perpendicular to each other, the extrusion spray head 4 is fixed at a position where the X axis 31 and the Y axis 32 intersects and can be moved along the X axis 31 and the Y axis 32 under the control of the drive module. The drive module comprises an X axis motor and a Y axis motor, both of which can be a step motor, a DC servo motor or any other appropriate motors. The X axis motor and the Y axis motor are both connected to the control module, wherein the X axis motor drives the extrusion spray head 4 to move long the X axis 31 under the control of the control module, and the Y axis motor drives the extrusion spray head 4 to move long the Y axis 32 under the control of the control module. The grating module 5 comprises an X axis grating scale 51, a Y axis grating scale 52, an X axis grating reader 53 and a Y axis grating reader 54, wherein the X axis grating scale 51 is fixed to the machine frame 1 and in parallel with the X axis 31; the Y axis grating scale 52 is fixed to the machine frame 1 and in parallel with the Y axis 32; the X axis grating reader 53 is fixed to one end of the Y axis 32 that is close to the X axis grating scale 51 and can be moved along the X axis grating scale 51 along with the movement of the Y axis 32, and the X axis grating reader 53 is connected to the control module for reading the data indicating the displacement of the extrusion spray head 4 along the X axis 31 in cooperation with the X axis grating scale 51; the Y axis grating reader 54 is fixed to one end of the X axis 31 that is close to the Y axis grating scale 52 and can be moved along the Y axis grating scale 52 along with the movement of the X axis 31, and the Y axis grating reader 54 is connected to the control module for reading the data indicating the displacement of the extrusion spray head 4 along the Y axis 32 in cooperation with the Y axis grating scale 52. Meanwhile, the control module comprises a compensation control unit for determining the number N′ of steps of the X axis step motor and the Y axis step motor which have been compensated according to the following formulas, in case that both the X axis motor and the Y axis motor are step motors:

$${N}^{′} = \frac{S}{p} + \frac{( M - m ) d}{p} , ( M > m )$$

$$or$$

$${N}^{′} = \frac{S}{p} + \frac{( m - M ) d}{p} , ( m > M )$$

wherein S is a distance of the extrusion spray head 4 required to move, p is the movement distance of extrusion spray head 4 driven by each step of the step motor; d is a grating spacing of the grating module 5; M is the number of gratings that the extrusion spray head 4 needs to pass through while the extrusion spray 4 moves by the distance S according to the printing data, and m is the number of gratings that the extrusion spray head 4 actually pass through.

In the above embodiment, if the X axis grating scale 51 and the Y axis grating scale 52 are strictly perpendicular to each other, an ideal rectangular coordinate system will be established in a plane where the X axis and the Y axis are, and the minimum graduation of the rectangular coordinate system is a grating spacing of the grating scale. However, due to existence of mechanical error, it cannot be ensured that the X axis grating scale 51 and the Y axis grating scale 52 which are installed on two sides of the machine frame are completely perpendicular to each other. Then, the rectangular coordinate system will occur rhombus distortion to affecting the final shape and accuracy of the printing model. Please refer to FIG. 11, which is a view showing a comparison between the coordinate system of X axis grating scale and Y axis grating scale in an ideal state and that in a twisted state.

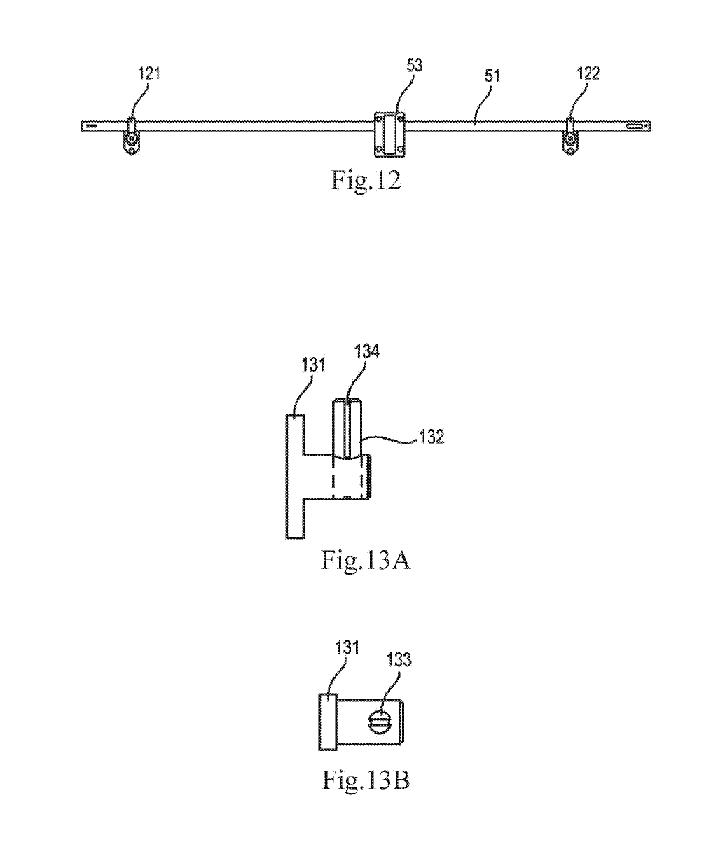

In order to avoid the occurrence of such a situation, in a preferable embodiment, at least one end of the X axis grating scale and/or the Y axis grating scale is fixed to the machine frame via a grating fine adjuster. Description will be given below with the X axis grating scale 51 as example. FIG. 12 is a schematic view of structure showing that both two ends of the X axis grating scale 51 are provided with the grating fine adjuster 121, 122. In other embodiments, the grating fine adjuster can be only provided at one end of the X axis grating scale 51.

FIG. 13A is a schematic view of the structure of grating fine adjuster 121, and FIG. 13B is a bottom view of FIG. 13A. The grating fine adjuster 121 comprises a fixed block 131 and an adjusting block 132. The fixed block 131 can be fixedly disposed on the machine frame 1 via a threaded connection or a snap connection in a fixed manner, whereas the connection between the adjusting block 132 and the fixed block 132 is a movable connection. As shown in FIGS. 13A and 13B, the adjusting block 132 is disposed in a threaded hole of the fixed block 131 and the relative position therebetween is adjusted by means of a straight slot 133. The adjusting block 132 is further provided with an insertion groove 134 for receiving the X axis grating scale 51. The adjusting block 132 is rotated by an action on straight slot 133, which can change the relative position between the insertion 134 and the fixed block 131 to adjust the position of the X axis grating scale 51 and make the X axis grating scale strictly perpendicular to the Y axis grating scale 52. A similar structure can be also applied to the adjusting block 132.

Two ends of the Y axis grating scale 52 can also be provided with the above-described grating micro-adjuster to adjust the position of the Y axis grating scale 52 and make the Y axis grating scale 52 strictly perpendicular to the X axis grating scale 51.

In the closed-loop control method for a printing running mechanism realized by using the high-speed 3D printer according to the preferable embodiment, the step (4) specifically comprises the following steps:

(41) the compensation control unit determines the number N′ of steps of the X axis step motor and the Y axis step motor which have been compensated according to the following formulas:

$${N}^{′} = \frac{S}{p} + \frac{( M - m ) d}{p} , ( M > m )$$

$$or$$

$${N}^{′} = \frac{S}{p} + \frac{( m - M ) d}{p} , ( m > M )$$

wherein S is a distance of the extrusion spray head 4 required to move, p is the movement distance of the extrusion spray head 4 driven by each step of the step motor; d is the grating spacing of the grating module 5; M is the number of gratings that the extrusion spray head needs to pass through while the extrusion spray moves by the distance S according to the printing data, and m is the number of gratings that the extrusion spray head 4 actually pass through.

(42) the compensation control unit determines the number ΔN of steps compensated for the X axis step motor or the Y axis step motor according to the following formulas:

ΔN=N′—N

wherein N is the number of steps required for the X axis step motor and the Y axis step motor when the extrusion spray head 4 moves by the distance S according to the printing data.

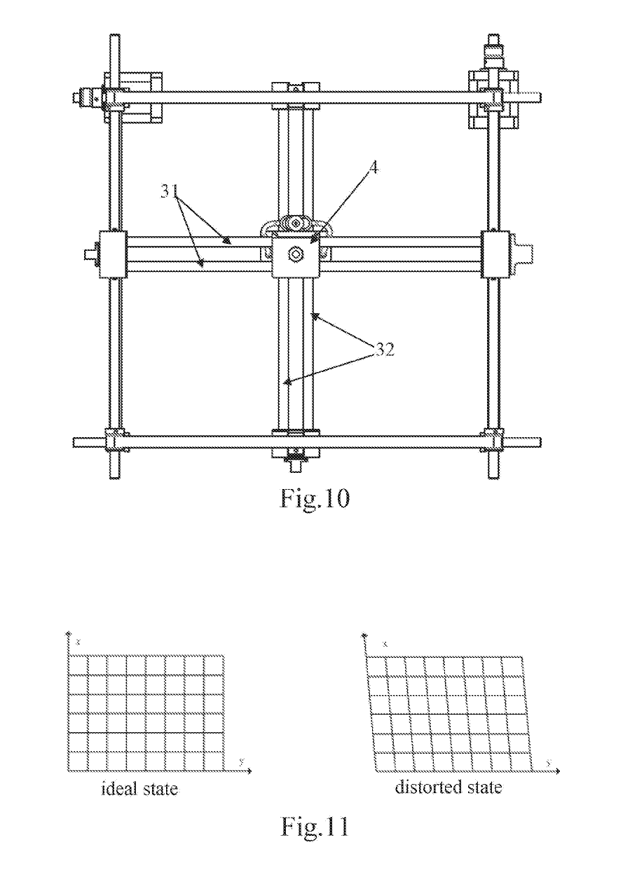

In a further preferably embodiment, the printing running mechanism 3 is a dual-crisscross printing running mechanism as shown in FIG. 10, which comprises two parallel X axes 31 and two parallel Y axes 32. The X axes 31 are perpendicular to the Y axes 32, and the extrusion spray head 4 is fixed at a position where the two X axes 31 and the two Y axes 32 intersect.

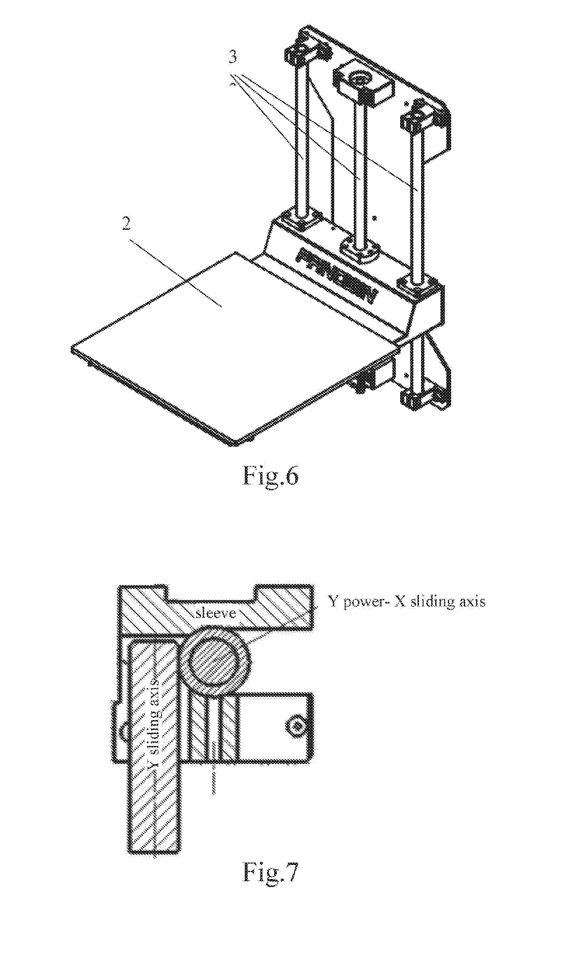

In a more preferably embodiment, as shown in FIG. 6, the printing running mechanism further comprises a Z axis 33, which is fixed to the machine frame 1 and is perpendicular to the X axis 31 and the Y axis 32. The printing platform 2 is connected to the Z axis 33 and is movable perpendicularly along the Z axis 33.

In the application of the invention, the high-speed 3D with fused deposition modeling printer according to the present invention comprises a main body of forming chamber with an overall steel frame structure which is formed by welding a streamline C-shaped frame, a back plate and a front panel, a dual-crisscross printing running mechanism with X, Y axes and Z axis assembly which are mounted on the frame structure. A liquid crystal display (LCD), a rotary encoding switch and a SD card reader, etc are fixedly mounted on the printer panel. A lower portion of the forming chamber is an electric appliance box which is integrally welded and closely combines with the forming chamber to form an overall rigid frame structure by the fixation of a countersunk screw. The extrusion spray head is mounted on a central slider of the dual-cross axes. The slider is provided with a roller bearing or a sleeve which is moving linearly and serves as a sliding bearing to be engaged with a sliding shaft, thus effectively reducing a fitting clearance. A lower portion of the central slider on the cross axes is provided with a heat resistant sleeve, an annular heat insulating block, a heating nozzle, etc., so as to form the extrusion spray head.

The printing running mechanism employs a unique dual-cross design with XY axes, or a “ [symbol] ”-shaped structure as shown in FIG. 5 which is further comprised with eight optical axes. The printing nozzle is mounted on a central slider of the dual-cross axes to distribute loads evenly onto the X axis and the Y axis. Such a design enables the driving motor to have a balanced and low load, which increases the printing speed. Four optical axes, which are an X axis driving-Y sliding axis, an X following-Y sliding axis, a Y driving-X sliding axis and a Y following-X sliding axis respectively, constitute a “ [symbol] ”-shaped structure at the periphery. The other four axes, which are two X sliding axes and two Y sliding axes respectively, constitutes a dual-cross structure.

The operational principle of the XY printing running mechanism is explained as follows: the X axis step motor drives the “X driving-Y sliding axis” to rotate via a synchronized belt, and “X driving-Y sliding axis” drives the “X following-Y sliding axis” to rotate via a synchronized belt, wherein the slider is fixed with the synchronized belts by its two sides. In this way, the slider can move linearly. The Y sliding axis is fixed with the sliders by its two sides and moves in synchronization with the sliders. Thus, the central slider of the cross axes can move linearly along the “X sliding axis”, forming an X-direction movement.

Similarly, the Y axis step motor drives the “Y driving-X sliding axis” to rotate via a synchronized belt, and “Y driving-X sliding axis” drives the “Y following-X sliding axis” to rotate via a synchronized belt, wherein the slider is fixed to the synchronized belts by its two sides. In this way, the slider can move linearly. The X sliding axis is fixed with the sliders by its two sides and moves in synchronization with the sliders. Thus, the “X sliding axis” drives the central slider of the cross axes to move linearly along the “Y sliding axis”, forming a Y-direction movement.

In order to ensure parallelism and perpendicularity in the X and Y directions to smooth the movement of the spray head mounted on the central slider of the cross axes and improve the running accuracy, the relative relationships among various driving axes should be determined.

Both the X axis and the Y axis are driven by a 42-step motor, wherein a motor shaft and a power shaft are both provided with a synchronized pulley. The gear ratio among individual synchronized gears is 1:1. The synchronized pulley can employ an S2M arc teeth synchronized pulley, of which the tooth pitch is 2 mm and the number of teeth is 20. The step angle of the step motor is 1.8 degree. The step motor can be driven by a subdivision control circuit with a maximum subdivision of 1/128. When a subdivision of 1/32 is set, a minimum resolution of the X axis movement and the Y axis movement can be calculated as follows:

(2×20)/(360/1.8×32)=0.00625 mm

That is 6.25 μm, a value of resolution can meet the requirements of accurate positioning control for the XY moving mechanism.

The simple and reliable structure of present invention effectively ensures the parallelism and perpendicularity of the X driving-Y sliding axis, the X following-Y sliding axis, the Y driving-X sliding axis and the Y following-X sliding axis with respect to the X sliding axis and the Y sliding axis.

In order to achieve the above object, as shown in FIG. 7, the Y driving-X sliding axis and the Y following-X sliding axis are sleeved over and slidingly fit with a copper sleeve respectively, then, the Y sliding axis is pressed onto the two copper sleeves. Therefore, the axis parallelism of the Y driving-X sliding axis, the Y following-X sliding axis with respect to the Y sliding axis is ensured. The other end of the X driving-Y sliding axis, the X following-Y sliding axis are also engaged with the X sliding axis in this way. The connection between the dual-cross axes and the “ [symbol] ”-shaped axes can be in a way of tangential contact with the optical axes, which can ensure the consistency of spacing between axes, so that the flatness of the cross running mechanism with XY axes can be well ensured.

As shown in FIG. 6, the Z axis portion of the running mechanism of the 3D printer in the invention is a mechanism assembly which is constituted by two optical axes with a diameter of 12 mm, a ball screw with a diameter of 12 mm and a pitch of 4 mm, a support bracket and a printing platform. The two optical axes and the screw are all mounted on a separate Z axis back plate via the support bracket. Therefore, the parallelism problem involved in assembling the three axes (two optical axes and a screw) of the Z axis can be well solved, thus ensuring a moving accuracy of the Z axis. The Z axis assembly is fixed onto the back plate of the machine frame via bolts.

The control system obtains an actual relative displacement and direction of two gratings by detecting pulse signals of phases A and B of the grating module. When the grating scale is fixed on the machine frame and the grating head moves with the displacement of the slide, accurate mechanical displacement information of the slide can be obtained. In the XY moving mechanism, an accurate synchronized movement of the slide can be achieved by the closed-loop control compensation, thus providing smoothness and accuracy for the movement.

(1) detection of direction of movement

Assuming that the phases of the A, B phase pulses are φA and φB respectively, and taking the A phase pulse as reference and left direction as a positive direction, then,

the slider will move towards the left, if φA>φB; or

the slider will move towards the right, if φA<ρB; therefore, the direction of movement of the slider is detected.

(2) correction of displacement of movement

Taking the X axis movement as example, the minimum resolution of the X axis movement is assumed as p mm, namely the slider moves by p mm with each step of the step motor, and the distance by which the slider needs to move for one movement control process is assumed as S, if an open-loop control is employed, the number of moving steps required for the step motor can be directly calculated as follows:

$$N = \frac{S}{p}$$

Assuming that the grating spacing of the grating scale is d, then the number of gratings that the slider needs to pass through is as follows, while the slider moves by distance S;

$$M = \frac{S}{d}$$

When the step motor is controlled to move N steps, the number m of gratings that the slide actually passes through can be obtained by counting the pulses, as that with each grating spacing passed by, the number of pulses will be increased by 1.

In an ideal situation, m=M; however, due to existence of error in open-loop control, m≠M in a real situation.

When m<M, the number of movement steps of the step motor has to be increased, and the correcting equation is:

$$\begin{matrix}{N}^{′} = N + Δ N \\ = \frac{S}{p} + \frac{( M - m ) d}{p}\end{matrix}$$

When m>M, the number of movement steps of the step motor has to be decreased, and the correcting equation is:

$$\begin{matrix}{N}^{′} = N - Δ N \\ = \frac{S}{p} + \frac{( m - M ) d}{p}\end{matrix}$$

After the correction, the number m′ of gratings that the slider actually passes through can be derived, m′=M, thus accurately controlling a movement distance S of the slider.

(3) XY moving mechanism closed-loop control

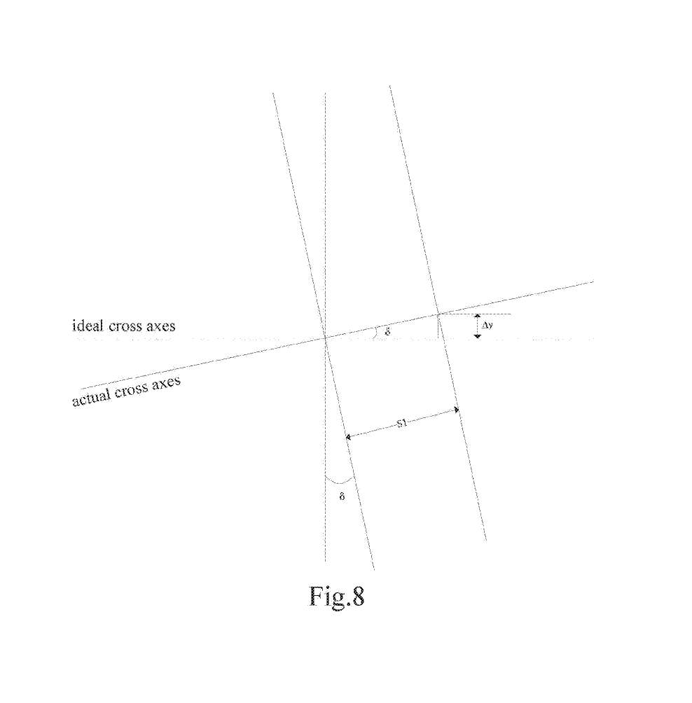

As shown in FIG. 8, in the XY moving mechanism of the invention, it is required that the “ [symbol] ”-shaped structure formed by four optical axes should be perpendicular with the dual-cross central axes structure so as to ensure that the X direction and Y direction of the moving system are in an ideal perpendicular relationship. However, due to existence of mechanical error, motor step-out, belt stretch-out and draw-back, etc., there can be a possible situation that the two structures are not completely perpendicular to each other.

Assuming that the dual cross axes is deviated from an ideal position by an angle δ, in a certain movement, only the X axis is controlled to move by a displacement Sx, as shown in the drawing as follows. Due to the error of angle δ, the single axis movement of the X axis will cause the Y axis to generate a corresponding an offset via a coupling of the central slider:

Δy=Sₓg sin δ

When an open-loop control is employed, the offset cannot be detected nor eliminated. The introduction of the closed-loop control enables this offset can be detected by the gratings of the Y axis, thus performing a real time correction through a closed-loop control algorithm. When the Y axis performs a single axis movement to cause the X axis to be deviated, the detection and correction can be also performed by the gratings of the X axis.

Therefore, the displacement error caused by such factors as belt stretch-out and draw-back, unequal mechanical steps of the motor and so on can be compensated, thus enabling an accurate control of the XY moving mechanism and greatly improving fineness, evenness and reliability of printing.

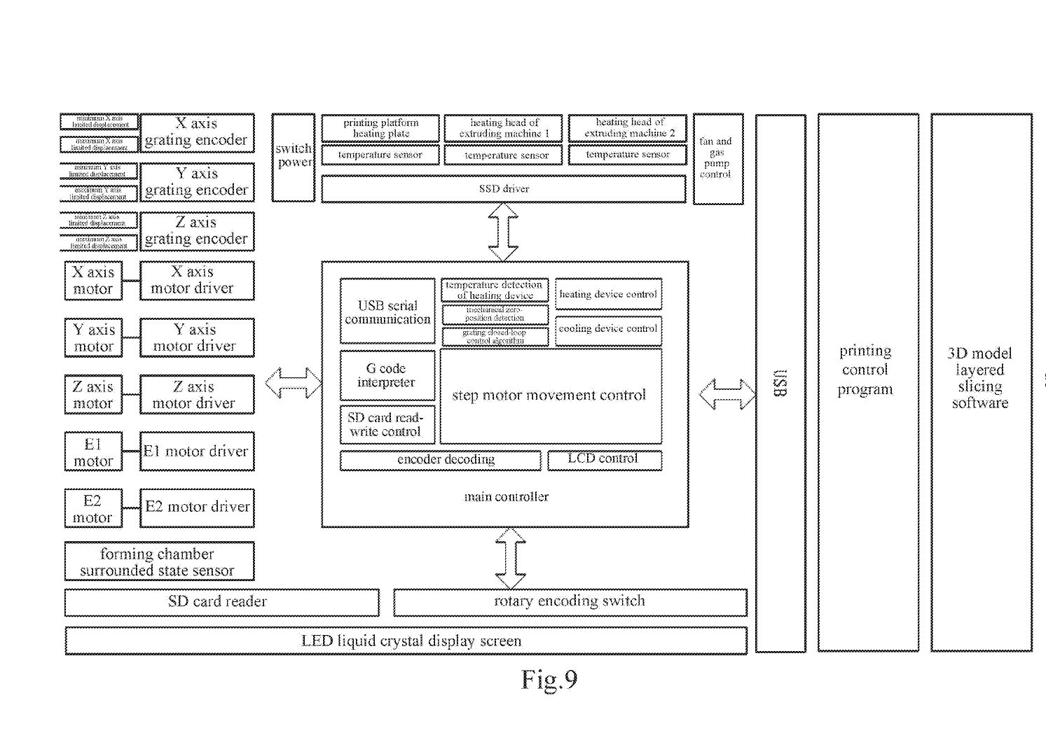

A control system block diagram of the 3D printer of present invention is shown in FIG. 9. The data of 3D model to be printed is converted into G codes through a layered slicing software, and is then transmitted by USB port or directly read by SD card via a printing control program. A main controller is mainly responsible for communication protocol processing, command interpretation, encoder decoding, movement control algorithm implementation, motor control, temperature control and human-computer interaction control, etc. Wherein X, Y, Z motors control the movement of a 3-coordiante mechanism, motors E1 and E2 control a first wire feeding mechanism and a second wire feeding mechanism respectively. The actual position information of X, Y, Z is read by the grating encoder, which is fed back to the main controller to realize the accurate positioning of the completely closed-loop 3D coordinates via the movement control algorithm and the closed-loop control algorithm.

The temperature of the nozzle is read by a K type thermocouple, and is converted by an amplifier into a voltage signal read by the main controller. The temperature of the nozzle is precisely controlled by a PID fuzzy control algorithm inside the main controller. The printing platform is heated by a heating plate mounted under the platform so as to enhance adhesion of the model onto the printing platform. The temperature of the printing platform is also read by a temperature sensor to be obtained by the main controller, and then the main controller performs temperature control via PID algorithm.

A refrigerating device adjusts power supply of a fan or gas pump so as to realize variation in intensity. The control signal is in the form of pulse width modulation (PWM), which is generated by the main controller and can be connected to a driving circuit. The temperature control algorithm inside the main controller also adjusts the control signal of the refrigerating device by reading the feedback from the temperature sensor, thus realizing a completely closed-loop control of the temperature.

With respect to the high-speed 3D printer with fused deposition modeling under closed-loop control and the closed-loop control method of the invention, since the 3D printer has the grating module in which the grating scale is fixed on the machine frame and the grating reader moves along with the running mechanism, a precise mechanical displacement information of the extrusion spray head can be obtained. For the printing running mechanism with XY axes, a precise movement compensation is realized through the compensation of the closed-loop control to improve the accuracy of the position of the extrusion spray head, and thus greatly improve the accuracy of 3D printing to be able to meet the technical requirements of high-accuracy printing. Moreover, the high-speed 3D printer with fused deposition modeling under closed-loop control of the invention has a relatively simple structure and low cost, and the control method of the invention is easy to implement and has a very wide range of application.

While the invention have been described herein with reference to particular embodiments thereof, it is obvious that various modifications and variations can be made thereto without departing the spirit and scope of the invention. Therefore, the specification and drawings should be construed as illustrative rather than limiting.

What is claimed is:

1. A high-speed 3D printer with fused deposition modeling under closed-loop control, comprising:
a machine frame:
a printing running mechanism connected to the machine frame;
a printing platform connected to the printing running mechanism:
an extrusion spray head connected to the printing running mechanism:
a drive module connected to and driving the printing running mechanism:
wherein, the high-speed 3D printer further comprises:
a grating module fixed to the machine frame and the printing running mechanism for detecting an actual displacement of the extrusion spray head; and
a control module for controlling the drive module according to a predetermined printing data and perform a compensating control according to an error between the actual displacement of the extrusion spray head and the printing data.

2. The high-speed 3D printer with fused deposition modeling under closed-loop control according to claim 1, wherein, the printing running mechanism is a crisscross printing running mechanism having an X axis and a Y axis that are perpendicular to each other; and, the extrusion spray head is fixed at a position where the X axis and the Y axis intersect with each other and can be moved along the X axis and the Y axis under the control of the drive module.

3. The high-speed 3D printer with fused deposition modeling under closed-loop control according to claim 2, wherein, the grating module comprises:
an X axis grating scale fixed to the machine frame and in parallel with the X axis;
a Y axis grating scale fixed to the machine frame and in parallel with the Y axis;
an X axis grating reader, which is fixed to one end of the Y axis that is close to the X axis grating scale, and can be moved along the X axis grating scale along with the movement of the Y axis and connected with the control module for reading a data which is indicating the displacement of the extrusion spray head along the X axis in cooperation with the X axis grating scale; and,
a Y axis grating reader, which is fixed to one end of the X axis that is close to the Y axis grating scale, and can be moved along the Y axis grating scale along with the movement of the X axis and connected with the control module for reading a data which is indicating the displacement of the extrusion spray head along the Y axis in cooperation with the Y axis grating scale.

4. The high-speed 3D printer with fused deposition modeling under closed-loop control according to claim 3, wherein, the drive module comprises:
an X axis motor, which is connected to the control module for driving the extrusion spray head to move along the X axis under the control of the control module; and,
a Y axis motor, which is connected to the control module for driving the extrusion spray head to move along the Y axis under the control of the control module.

5. The high-speed 3D printer with fused deposition modeling under closed-loop control according to claim 4, wherein, the control module comprises a compensation control unit, and if both the X axis motor and the Y axis motor are step motors, the compensation control unit determines the number N′ of steps of the X axis step motor and the Y axis step motor which have been compensated according to the following formulas:
$${N}^{′} = \frac{S}{p} + \frac{( M - m ) d}{p} , ( M > m )$$
$$or$$
$${N}^{′} = \frac{S}{p} + \frac{( m - M ) d}{p} , ( m > M )$$
wherein S is a distance of the extrusion spray head required to move, p is a movement distance of the extrusion spray head driven by one step of the step motor; d is a grating spacing of the grating module; M is the number of gratings that the extrusion spray head needs to pass through while the extrusion spray moves by the distance S according to the printing data, and m is the number of gratings that the extrusion spray head actually pass through.

6. The high-speed 3D printer with fused deposition modeling under closed-loop control according to claim 3, wherein, at least one end of the X axis grating scale and/or the Y axis grating scale is fixed to the machine frame via a grating fine adjuster, and the grating fine adjuster comprises a fixed block and an adjusting block:
the fixed block is fixedly disposed onto the machine frame; and,
the adjusting block is movably connected with the fixed block and further provided with an insertion groove for receiving the grating scale.

7. The high-speed 3D printer with fused deposition modeling under closed-loop control according to claim 2, wherein, the printing running mechanism is a dual-crisscross printing running mechanism having two parallel X axes and two parallel Y axes; and, the X axes are perpendicular to the Y axes, and the extrusion spray head is fixed at a position where the two X axes and the two Y axes intersect.

8. The high-speed 3D printer with fused deposition modeling under closed-loop control according to claim 2, wherein, the printing running mechanism further comprises a Z axis which is fixed to the machine frame and perpendicular to the X axis and the Y axis; and, the printing platform is connected to the Z axis and moves along the Z axis perpendicularly.

9. A closed-loop control method for a printing running mechanism by using the high-speed 3D printer with fused deposition modeling according to claim 1, wherein, the method comprises the following steps:
(1) the drive module controls a movement of the printing running mechanism according to the printing data;
(2) the grating module detects an actual displacement of the extrusion spray head:
(3) the control module compares the actual displacement with the printing data so as to determine the error:
(4) the control module controls the drive module to perform compensation according to the error.

10. The closed-loop control method for a printing running mechanism by using the high-speed 3D printer with fused deposition modeling according to claim 9, wherein the printing running mechanism is a crisscross printing running mechanism having an X axis and a Y axis that are perpendicular to each other, the drive module comprises an X axis step motor and a Y axis step motor, the control module comprises a compensation control unit, and the step (4) specifically comprises the following steps:
(41) the compensation control unit determines the number N′ of steps of the X axis step motor and the Y axis step motor which have been compensated according to the following formulas:
$${N}^{′} = \frac{S}{p} + \frac{( M - m ) d}{p} , ( M > m )$$
$$or$$
$${N}^{′} = \frac{S}{p} + \frac{( m - M ) d}{p} , ( m > M )$$
wherein S is a distance of the extrusion spray head required to move, p is the movement distance of the extrusion spray head driven by one step of the step motor; d is the grating spacing of the grating module; M is the number of gratings that the extrusion spray head needs to pass through while the extrusion spray moves by the distance S according to the printing data, and m is the number of gratings that the extrusion spray head actually pass through:
(42) the compensation control unit determines the number ΔN of steps compensated for the X axis step motor or the Y axis step motor according to the following formulas:
ΔN=N′—N
wherein N is the number of steps required for the X axis step motor and the Y axis step motor when the extrusion spray head moves by the distance S according to the printing data.

11. The closed-loop control method according to claim 9, wherein the printing running mechanism is a crisscross printing running mechanism provided with an X axis and a Y axis that are perpendicular to each other, the drive module comprises an X axis step motor and a Y axis step motor, the control module comprises a compensation control unit, and the step (3) further comprises steps of determining non-perpendicularity error of the X axis or Y axis in case that the cross axes formed by the X axis and the Y axis is deviated from an ideal position by an angle δ, as follows:
(31) Merely controlling the X axis to move by a displacement Sₓ, wherein the single axis movement of the X axis will cause a corresponding offset of Y axis via the coupling of a central slider:
Δy=Sₓg sin δ
(32) Detecting the offset of Y axis as the non-perpendicularity error of the Y axis for modifying the displacement of the Y axis in step (4); and in the above steps, the X axis and the Y axis can be exchanged.
